(19) United States
(12) Patent Application Publication
(10) Pub. No.: US 2026/0301520 A1
(43) Pub. Date: Oct. 1, 2026

(54) GAME SYSTEM WITH VARIABLE PAYOUT ODDS AND AUGMENTED REALITY GAMEPLAY FUNCTIONALITY, AND METHOD FOR PROVIDING AN AUGMENTED REALITY GAMEPLAY EXPERIENCE FOR THE SAME

(71) Applicant: JUMBO TECHNOLOGY CO., LTD., Taichung City (TW)

(72) Inventors: Shun-Tsung HSU, Taichung City (TW); Chang-Yi WANG, Taichung City (TW)

(21) Appl. No.: 19/700,922

(22) Filed: Jun. 8, 2026

Related U.S. Application Data
(63) Continuation-in-part of application No. 19/193,645, filed on Apr. 29, 2025.
Application No. 19/193,645 is a continuation of application No. 19/072,196, filed on Mar. 6, 2025, now abandoned.
Application No. 19/072,196 is a continuation-in-part of application No. 17/915,980, filed on Apr. 1, 2020, now Pat. No. 12,249,214.
Application No. 19/072,196 is a continuation-in-part of application No. 18/251,793, filed on Dec. 3, 2020.

(51) Int. Cl. G07F 17/32; G06T 7/70

(52) U.S. Cl. CPC G07F 17/323; G06T 7/70; G07F 17/3209; G07F 17/3211

(57) ABSTRACT

A game system includes a physical game result generator, an image capturing device configured to generate a real-time image that includes the physical game result generator captured in real time, a display, a payout unit, and a processor. The processor is configured to generate a betting layout image that includes a plurality of virtual betting areas each assigned with a payout odds value, update the betting layout image based on betting data, update the payout odds values based on payout option data, control the display to display the real-time image and the betting layout image that has been updated simultaneously, control the physical game result generator to randomly generate a game result, calculate a payout amount based on the game result, the betting data and the payout odds values, and control the payout unit to deliver a payout based on the payout amount thus calculated.

### CROSS-REFERENCE TO RELATED APPLICATION

This is a continuation-in-part of U.S. patent application Ser. No. 19/193,645, filed on Apr. 29, 2025, which is a continuation of co-pending U.S. patent application Ser. No. 19/072,196, filed on Mar. 6, 2025, which is:
a continuation-in-part of U.S. patent application Ser. No. 17/915,980, filed on Sep. 29, 2022, which is a national stage entry of International Application Ser. No. PCT/CN2020/082704, filed on Apr. 1, 2020; and
a continuation-in-part of U.S. patent application Ser. No. 18/251,793, filed on May 4, 2023, which is a national stage entry of International Application Ser. No. PCT/CN2020/133669, filed on Dec. 3, 2020.

The aforesaid applications are incorporated by reference herein in their entirety.

### FIELD

The disclosure relates to a game system with variable payout odds and augmented reality gameplay functionality, and a method for providing an augmented reality gameplay experience for a game system with variable payout odds and augmented reality gameplay functionality.

### BACKGROUND

A conventional game system for playing a gambling game includes a display for displaying a plurality of betting areas. Each of the betting areas corresponds to a game result generated by the conventional game system and includes a payout odds value and a probability of occurrence of the corresponding game result. The payout odds values are respectively displayed in the betting areas. Conventionally, the payout odds values of the betting areas are determined by, for each betting area, either using a default odds value based on a set of conventional payout odds values for the gambling game or selecting one of a plurality of variable odds values to update the payout odds value in the betting area. The variable odds values are determined in such a manner that an average Return to Player (RTP) of the gambling game is increased in order to attract players to play the gambling game. The RTP of the gambling game refers to a percentage of wagers placed by a player that is returned to the player over time.

However, increasing the average RTP of the gambling game sacrifices the operating profit of the game dealer operating the conventional game system. For the game dealer, although a higher RTP may increase turnover by attracting players to play the gambling game multiple times, it is unfavorable to operating profit. Conversely, when the increase in the average RTP of the gambling game is limited to maintain acceptable operating profit, the variable odds values that are generated tend to be very similar to the conventional payout odds values, which fails to provide additional incentives for players to play the gambling game.

In addition, the conventional game system uses a virtual random number generator to generate the game result for the gambling game, which fails to provide a deeply immersive experience.

A conventional way of enabling players that are playing the gambling game remotely to observe a physical game result generator is to provide an additional display screen that displays a real-time scene of the physical game result generator generating the game result (e.g., through online live streaming). However, this approach requires players to pay attention to both the display showing the betting areas with the payout odds values and the display screen showing the physical game result generator. As a result, players are often distracted by having to view both the display screen and the display simultaneously. This can be mentally exhausting and may lead to players playing fewer rounds of the gambling game, thereby reducing the turnover of the conventional game system.

### SUMMARY

Therefore, an object of the disclosure is to provide a game system with variable payout odds and augmented reality gameplay functionality and a method for providing an augmented reality gameplay experience for a game system with variable payout odds and augmented reality gameplay functionality that can alleviate at least one of the drawbacks of the prior art.

According to an aspect of the disclosure, the game system is provided for playing at least one round of a gambling game. The game system includes a physical game result generator, an image capturing device, an input unit, a display, a payout unit, and a processor. The physical game result generator is configured to randomly generate a game result in each round of the gambling game. The image capturing device is configured to capture, in real time, an image of a scene including the physical game result generator to generate a real-time image, and to output the real-time image. The input unit is configured to generate betting data and payout option data in response to user operations performed on the input unit, and to output the betting data and the payout option data. The display is configured to display the real-time image and a betting layout image simultaneously. The payout unit is configured to deliver a payout to the player. The processor is communicatively connected to the physical game result generator, the image capturing device for receiving the real-time image therefrom, the input unit for receiving the betting data and the payout option data therefrom, and the display. The processor is configured to generate the betting layout image based on the gambling game currently being played, where the betting layout image includes a plurality of virtual betting areas each assigned with a payout odds value, update the betting layout image based on the betting data, update the payout odds values respectively of the virtual betting areas based on the payout option data, control the display to display the real-time image and the betting layout image that has been updated, control the physical game result generator to randomly generate the game result, calculate a payout amount based on the game result, the betting data and the payout odds values respectively of the virtual betting areas, and control the payout unit to deliver the payout based on the payout amount thus calculated.

According to another aspect of the disclosure, the method is implemented by the processor of the game system mentioned above. The method includes steps of: receiving the real-time image from the image capturing device; generating the betting layout image based on the gambling game currently being played; updating, in response to receipt of the betting data from the input unit, the betting layout image based on the betting data; updating, in response to receipt of the payout option data from the input unit, the payout odds values respectively of the virtual betting areas based on the payout option data; controlling the display to display the real-time image and the betting layout image that has been updated; controlling the physical game result generator to randomly generate the game result; calculating the payout amount based on the game result, the betting data and the payout odds values respectively of the virtual betting areas; and controlling the payout unit to deliver the payout based on the payout amount thus calculated.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a game system with variable payout odds and augmented reality gameplay functionality according to an embodiment of the present disclosure.

FIG. 2 is a flow chart illustrating a first embodiment of a method for providing an augmented reality gameplay experience for the game system in FIG. 1.

FIG. 3 is a perspective view illustrating a first example of a physical game result generator according to an embodiment of the present disclosure.

FIGS. 4A to 4C are schematic diagrams illustrating augmented images that are displayed on a display of the game system during gameplay of a gambling game that corresponds to the first example of the physical game result generator.

FIG. 5 is a flow chart illustrating a second embodiment of the method for providing an augmented reality gameplay experience for the game system in FIG. 1.

FIGS. 6A and 6B are schematic diagrams illustrating betting layout images that are displayed during gameplay of a gambling game that corresponds to a second example of the physical game result generator.

FIGS. 7A and 7B are schematic diagrams illustrating betting layout images that are displayed during gameplay of a gambling game that corresponds to a third example of the physical game result generator.

FIG. 8 is a block diagram illustrating the game system with variable payout odds and augmented reality gameplay functionality according to some embodiments of the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

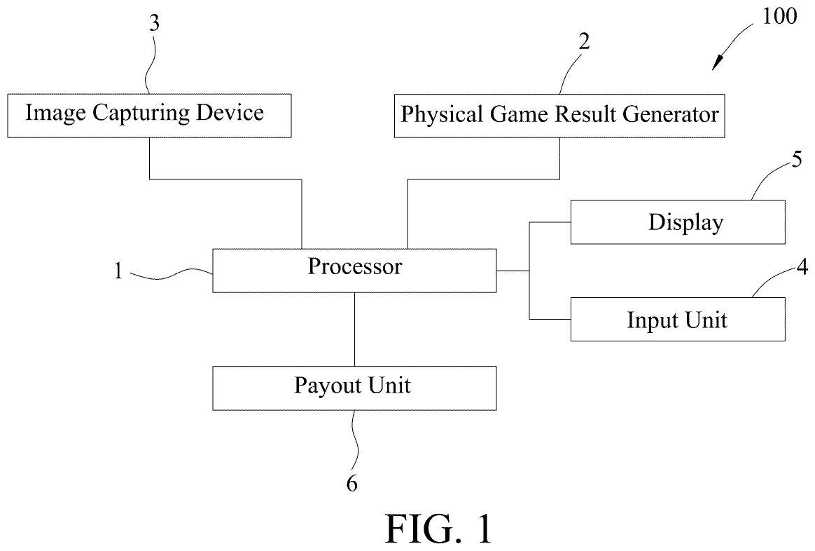

Referring to FIG. 1, a game system 100 with variable payout odds and augmented reality gameplay functionality according to an embodiment of the present disclosure includes a processor 1, and a physical game result generator 2, an image capturing device 3, an input unit 4, a display 5, and a payout unit 6 that are connected to the processor 1. The game system 100 is provided for allowing a player to play at least one round of a gambling game that corresponds to the physical game result generator 2. The gambling game may include, but is not limited to, a roulette game, a baccarat game, or a Sic Bo game. For illustration purposes, the roulette game is used hereinafter as a first example of the gambling game currently being played to describe the game system 100 of the present disclosure.

In this embodiment, the processor 1 may include, for example, at least one of, a multi-core processor, a dual-core mobile phone processor, a microprocessor, a digital signal processor (DSP), a field programmable gate array (FPGA) and an application-specific integrated circuit (ASIC). For example, the processor 1 may be exemplified as a central processing unit (CPU), a micro-processing unit (MPU), a graphics processing unit (GPU), a tensor processing unit (TPU), or a combination thereof, but the processor 1 is not limited to such.

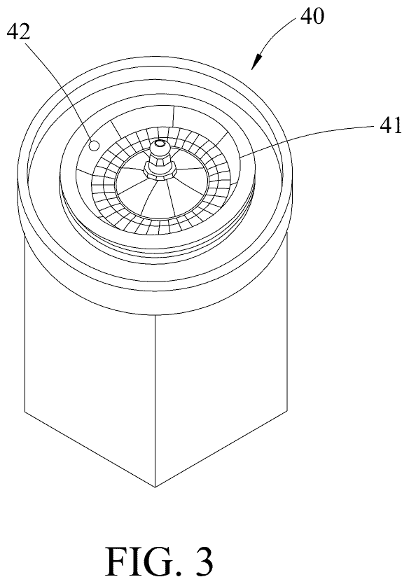

The physical game result generator 2 is configured to randomly generate a game result in each round of the gambling game. Specifically, the game result is one of a plurality of possible results that may be generated by the physical game result generator 2 and that are different from each other. Each of the possible results has a probability of occurrence. In this embodiment, the physical game result generator 2 may be embodied as a roulette device 40 (as shown in FIG. 3) for playing the roulette game, a card dealing device for playing the baccarat game, or a dice rolling device for playing the Sic Bo game; however, the physical game result generator 2 is not limited thereto. In the first example, the physical game result generator 2 is exemplified by the roulette device 40. The roulette device 40 includes a roulette wheel 41 and a roulette ball 42. The roulette wheel 41 has a European-style layout with numbers from “0” to “36”, which correspond to the possible results that may be generated by the physical game result generator 2. In this first example, the game result is defined by the pocket into which the roulette ball 42 falls after the roulette wheel 41 stops rotating.

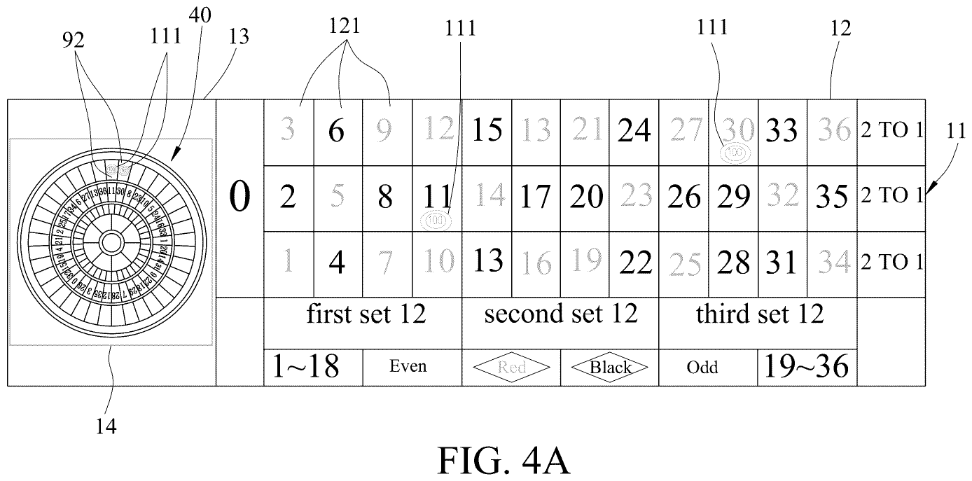

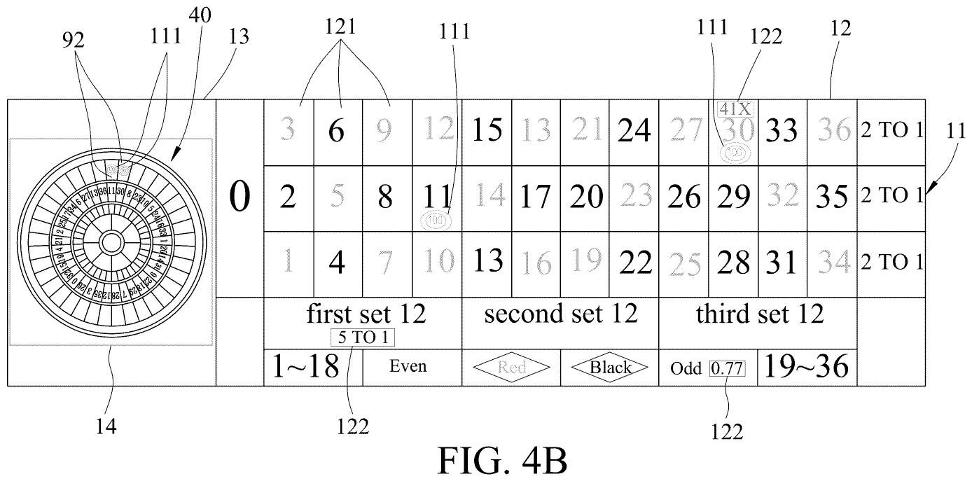

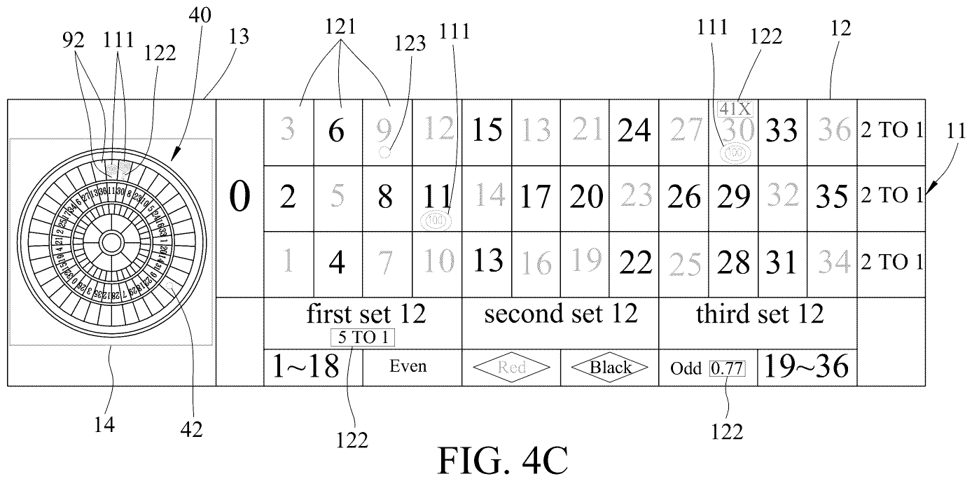

The image capturing device 3 is configured to capture, in real time, an image of a scene including the physical game result generator 2 so as to generate a real-time image 13 (see FIG. 4A), and to transmit the real-time image 13 to the processor 1. In this embodiment, the image capturing device 3 may be exemplified by a digital camera, a video camera, a network (IP) camera or an industrial camera, and is not limited thereto.

The input unit 4 is provided for allowing a player to perform operations thereon, and is configured to generate betting data and payout option data based on the operations performed thereon by the player, and transmit the betting data and the payout option data to the processor 1. In this embodiment, the input unit 4 may be embodied using a keyboard, a gaming console, or a touchscreen module, but is not limited thereto. The betting data includes a bet amount (e.g., a wager of 100 credits) and a target betting area (e.g., a virtual betting area 121 of “Area_ID: 9”) selected by the player. The payout option data indicates a selection by the player of a set of parameters for determining payout odds of each round of the gambling game. Details of the payout option data will be described later.

Further referring to FIG. 4A, the display 5 is configured to display an augmented image 11 that includes the real-time image 13 and a betting layout image 12 that is computer-generated and corresponds to the gambling game currently being played. Accordingly, the augmented image 11 enables the player to view the physical game result generator 2 in real time (i.e., viewing the real-time image 13) and the betting layout image 12 simultaneously on the display 5. Specifically, the betting layout image 12 includes a plurality of virtual betting areas 121 that correspond to the possible results of the physical game result generator 2. The game result in each round of the gambling game corresponds to at least one of the virtual betting areas 121. The virtual betting areas 121 are respectively assigned with a plurality of payout odds values. For example, in a roulette game, the virtual betting areas 121 that correspond to single numbers from “0” to “36” are each assigned with a payout odds value of 35. The display 5 may be embodied using a liquid-crystal display (LCD), but is not limited thereto. In one embodiment, the input unit 4 may be integrated with the display 5 as a single unit (e.g., a touchscreen display) to provide both input and display functions for the player to play the gambling game; however, the disclosure is not limited in this respect.

The processor 1 is configured to receive the real-time image 13 from the image capturing device 3, generate the betting layout image 12 based on the gambling game currently being played, generate the augmented image 11 by compositing the real-time image 13 and the betting layout image 12, and control the display 5 to display the augmented image 11. The betting data includes data indicating that a wager is placed on at least one of the virtual betting areas 121 for each round of the gambling game. The processor 1 is configured to, in response to receipt of the betting data from the input unit 4, generate the betting layout image 12 that further includes a virtual representation of a gaming token (e.g., a casino chip) (hereinafter referred to as “the virtual chip 111”) placed on said at least one of the virtual betting areas 121 according to the betting data.

Further referring to FIG. 4B, the processor 1 is configured to generate the betting layout image 12 that further includes a plurality of virtual payout-odds indicators 122 that are virtual representations of the payout odds values, respectively. The virtual payout-odds indicators 122 are respectively located at the virtual betting areas 121 (only some of the virtual payout-odds indicators 122 are shown in FIG. 4B for illustration purposes). The processor 1 is further configured to, in response to receipt of the payout option data from the input unit 4, calculate and update the payout odds values based on the payout option data. The virtual payout-odds indicators 122 in the betting layout image 12 correspond respectively to the payout odds values thus updated.

Specifically, the processor 1 stores a default payout-odds data set and a variable payout-odds data set. The default payout-odds data set includes a plurality of default odds values that correspond respectively to the virtual betting areas 121, and the default odds values may be conventional payout odds values used in the gambling game currently being played. In this embodiment, the payout odds values are respectively assigned as the default odds values in a default setting. The variable payout-odds data set includes a plurality of variable odds groups that correspond respectively to the virtual betting areas 121, and each of the variable odds groups includes a plurality of variable odds values each having a probability of appearance (POA). In this embodiment, for each of the variable odds groups, a sum of the probabilities of appearance (POAs) respectively of the variable odds values is 100 percent. By virtue of the above arrangement, each of the virtual betting areas 121 corresponds to a respective one of the default odds values and a respective one of the variable odds groups. In this embodiment, for each of the variable odds groups, at least one of the variable odds values is smaller than the respective one of the default odds values, and at least one of the remaining ones of the variable odds values is greater than or equal to the respective one of the default odds values. The default payout-odds data set and the variable payout-odds data set of this first example are shown in Table 1 below, where the entries (27, 41, 101, 168), (1, 5) and (0.77, 3) exemplify specific variable odds groups within the variable payout-odds data set.

TABLE 1

| Virtual Betting | | Default | Variable Odds | Selection |
|---|---|---|---|---|
| Area 121 | | Odds Values | Values | probabilities |
| Numerals | 0~36 | 35 | (27, 41, 101, 168) | (83%, 10%, 5%, 2%) |
| Sets | 1~12 | 2 | (1, 5) | (75%, 25%) |
| | (First set) | | | |
| | 13~24 | | | |
| | (Second set) | | | |
| | 25~36 | | | |
| | (Third set) | | | |
| Odd | 1, 3 ... 35 | 1 | (0.77, 3) | (90%, 10%) |
| Even | 2, 4 . . . 36 | | | |

In this embodiment, for each virtual betting area 121, a return to player (RTP) of the virtual betting area 121 is calculated using the following formula: RTP=(1+PayOdds)×ResProb, where “1” refers to an original wager placed by the player, “PayOdds” refers to the payout odds value corresponding to the virtual betting area 121, and “ResProb” refers to a probability of the game result corresponding to the virtual betting area 121 (i.e., a probability of the player winning the bet). In a case where the default payout-odds data set is used as the payout odds values for the virtual betting areas 121, the “PayOdds” is set as the default odds value that corresponds to the virtual betting area 121. For example, according to Table 1, and for each of the virtual betting areas 121 that is one of the numerals 0 to 36, the “PayOdds” is set as 35, and the “ResProb is 1/37. In another case where a corresponding one of the variable odds groups of one of the at least one variable payout-odds data set is used to update the payout odds value of the virtual betting area 121, the “PayOdds” is calculated by summing products of each variable odds value of said corresponding one of the variable odds groups with its corresponding POA. For example, according to Table 1, for each of the virtual betting areas 121 that is one of the numerals 0 to 36, the “PayOdds” is (27×83%)+(41×10%)+(101×5%)+(168×2%). An RTP of the gambling game is maintained at less than 100 percent. That is, on average and over a large number of rounds, a player receives back less than 100 percent of an amount wagered by the player. Specifically, the RTP of the gambling game is obtained based on the probability of occurrence of each of the possible results and the payout odds values of the virtual betting areas 121. That is, the RTP of the gambling game is obtained by calculating an average RTP of the virtual betting areas 121.

In this embodiment, for each of the variable odds groups, the variable odds values and their corresponding POAs are predetermined such that the RTP of the corresponding one of the virtual betting areas 121 calculated using the variable odds group is less than 100 percent, and a difference between the RTP of the corresponding one of the virtual betting areas 121 calculated using the default odds value and the RTP of said virtual betting areas 121 calculated using the variable odds group (hereinafter referred to as “the RTP difference”) satisfies a predetermined condition set by an operator of the game system 100 (e.g., the RTP difference being substantially zero or being within a predetermined range based on business requirements). By virtue of the aforementioned arrangement, for each of the variable odds groups, by making at least one of the variable odds values smaller than the respective one of the default odds values, at least one of the variable odds values can be made greater than the respective one of the default odds values so as to be more attractive to the player while maintaining the RTP difference of the corresponding one of the virtual betting areas 121 so as to satisfy the predetermined condition.

In some embodiments, the player may selectively input, via the input unit 4, an upper limit value, and/or a lower limit value of the variable odds values in each of the variable odds groups. In other embodiments, the player may further selectively input a number of the variable odds values in each of the variable odds groups. In these embodiments, the processor 1 generates, for each of the variable odds groups, the variable odds values and their corresponding POAs further based on the upper limit value, the lower limit value, and/or the number of the variable-odds-values. Specifically, the processor 1 may first randomly generate, for each of the variable odds groups, the variable odds values and their corresponding POAs based on the upper limit value, the lower limit value, and/or number of the variable-odds-values set by the player, and then calculate the RTP difference of each of the virtual betting areas 121. The processor 1 may generate the variable odds values for each of the variable odds groups by a mathematical method such as, but not limited to, Brute Force. For each of the virtual betting areas 121, if the RTP difference calculated does not satisfy the predetermined condition, the processor 1 may adjust the variable odds values and their corresponding POAs such that the RTP difference satisfies the predetermined condition. An RTP difference of the gambling game is obtained by averaging the RTP differences of the virtual betting areas 121. By maintaining the RTP difference of the gambling game to be substantially close to zero or within the predetermined range based on business requirements, the variable odds values and their corresponding POAs may be adjusted to be attractive to players while ensuring profitability.

In this embodiment, the payout option data is obtained from the variable payout-odds data set to update the payout odds values. For example, the processor 1 may generate a random number or may obtain a random number from a pseudo random number generator (PRNG), and determine one of the variable odds values as an adjusted odds value based on the POAs and the random number thus generated or obtained; however, the disclosure is not limited in this respect. Specifically, the processor 1 first generates an adjusted payout-odds data set that includes a plurality of adjusted odds values based on the payout option data. The adjusted odds values correspond respectively to the variable odds group of said one of the at least one variable payout-odds data set. Specifically, for each of the adjusted odds values, the processor 1 determines one of the variable odds values of the corresponding one of the variable odds groups as the adjusted odds value based on the POAs respectively of the variable odds values. Since ways of using random numbers to determine one of the variable odds values as the adjusted odds value based on the POAs are well known in the art, further description thereof is omitted for the sake of brevity. After the processor 1 has generated the adjusted payout-odds data set, the processor 1 updates the payout odds values respectively with the adjusted odds values of the adjusted payout-odds data set thus generated.

The processor 1 is configured to, after the physical game result generator 2 has generated a game result (i.e., generating game-result data), perform image processing on the real-time image 13. In this first example, the game-result data includes an identifier of the virtual betting area 121 (hereinafter Area_ID) corresponding to the pocket into which the roulette ball 42 falls. For example, the roulette ball 42 falls into the pocket “number 9,” then the game-result data includes “Area_ID: 9”. After generating the game-result data, the processor 1 calculates a payout amount based on the game-result data, the betting data and the payout odds values respectively of the virtual betting areas 121. Specifically, the image processing may include, as appropriate for the type of gambling game currently being played: optical character recognition (OCR) to detect numeric characters on the roulette wheel 41 in the roulette game, alphabetic or numeric characters on cards dealt in the baccarat game, or values on dice rolled in the Sic Bo game; Hough Circle Transform and template matching to identify positions of the pockets in the roulette game; homography and semantic segmentation to identify positions of betting boxes in the baccarat game; and perspective transformation and contour detection to identify positions of betting grids in the Sic Bo game. A sensor (e.g., an optical sensor) may also be used to detect the landing position of the roulette ball 42 (i.e., which pocket the roulette ball 42 falls into).

The payout unit 6 may include one or more devices capable of delivering a payout to the player, such as a coin hopper, a bill dispenser, a ticket printing device, an electronic account crediting system, or the like. After the processor 1 has determined the payout amount, the processor 1 controls the payout unit 6 to dispense cash, issue a payout ticket corresponding to the payment amount, or credit the payout amount to the player's account.

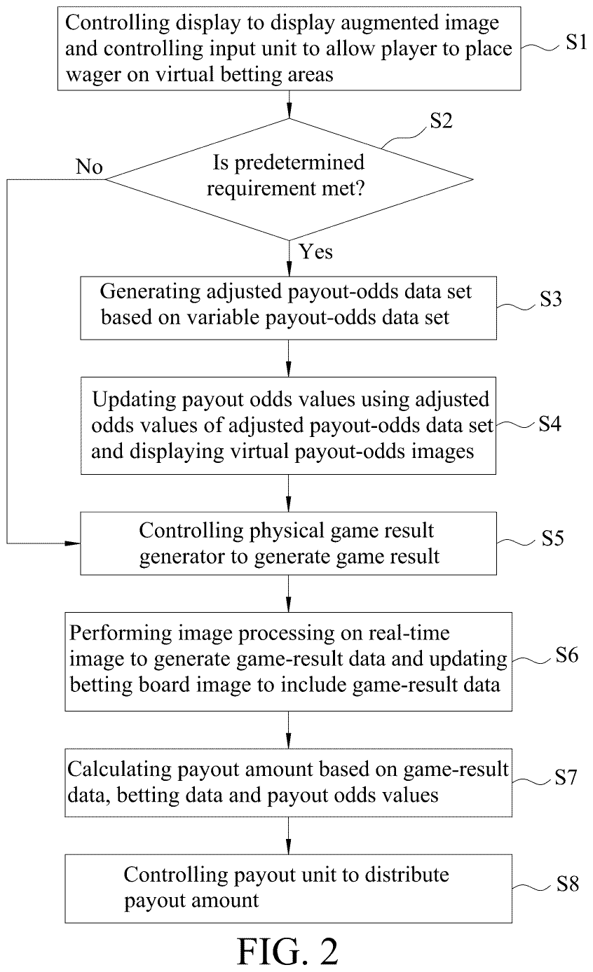

Further referring to FIG. 2, a first embodiment of a method for providing an augmented reality gameplay experience for a game system according to the present disclosure is implemented by the game system 100. The method includes steps S1 to S8.

In step S1, the processor 1 controls the display 5 to display the augmented image 11 that includes the betting layout image 12 and the real-time image 13, and controls the input unit 4 to allow the player to place a wager on at least one of the virtual betting areas 121 within a predetermined betting time. In this first example, the player places a first wager on one of the virtual betting areas 121 that corresponds to the number “30” (hereinafter referred to as “the single-bet-30 121”) and a second wager on another one of the virtual betting areas 121 that corresponds to the number “11” (hereinafter referred to as “the single-bet-11 121”). In response to the predetermined betting time having lapsed, the input unit 4 then generates the betting data that includes the first wager on the single-bet-30 121 and second wager on the single-bet-11 121, and transmits the betting data to the processor 1. The processor 1, in response to receipt of the betting data, updates the betting layout image 12 to include two virtual chips 111 respectively placed at the single-bet-30 121 and the single-bet-11 121. The processor 1 further generates a mask image 14 that is overlaid on top of the real-time image 13. The mask image 14 includes a plurality of display frames 92 that correspond respectively to pockets on the physical game result generator 2 in the real-time image 13, the pockets respectively representing the possible results (i.e., the numbers 0 to 36). The processor 1 is further configured to update the mask image 14 by generating two additional virtual chips 111 respectively on two of the display frames 92 that correspond respectively to the number “30” and the number “11” of the roulette wheel 41. When the mask image 14 is overlaid on the real-time image 13, the two additional virtual chips 111 appear at the pockets that correspond respectively to the number “30” and the number “11” of the roulette wheel 41.

In step S2, the processor 1 determines whether a predetermined requirement that is related to the betting data is met. The predetermined requirement is, for example, but not limited to, that a total wager that is a sum of wagers (e.g., a sum of an original wager and an additional wager) placed on each of the virtual betting areas 121 exceeds a predetermined wager amount set by the operator of the game system. In other embodiments, the processor 1 may generate the betting layout image 12 to include an additional betting area (not shown), and in such embodiments, the predetermined requirement is that a bet is placed on the additional betting area. In some embodiments, step S2 may be omitted, and thus the flow may go directly to step S3 after step S1 has been executed.

In response to an affirmative determination, the flow proceeds to step S3; otherwise, the flow proceeds to step S5.

In step S3, the processor 1 generates the adjusted payout-odds data set based on the variable payout-odds data set. In this first example, the processor 1 generates the adjusted payout-odds data set based on the variable payout-odds data set shown in Table 1. For the sake of brevity, only the default odds values and the adjusted odds values that correspond to the virtual betting areas 121 corresponding respectively to the number “30”, the first set of numerals (1~12) and the odd number numerals (1, 3 . . . 35) are shown in Table 2.

TABLE 2

| Virtual Betting Areas 121 | | Default Odds Values | Adjusted Odds Values |
|---|---|---|---|
| Numeral | 30 | 35 | 41 |
| First set | 1~12 | 2 | 5 |
| Odd | 1, 3 ... 35 | 1 | 0.77 |

In embodiments where the processor 1 stores a plurality of variable payout-odds data sets, the processor 1 controls the display 5 to display the variable payout-odds data sets, and controls the input unit 4 to allow the player to select one of the variable payout-odds data sets to be used to update the payout odds values. The input unit 4 then generates the payout option data and transmits the payout option data to the processor 1. The processor 1 then generates the adjusted payout-odds data set based on said one of the variable payout-odds data sets.

Further referring to FIG. 4B, in step S4, the processor 1 updates the payout odds values respectively of the virtual betting areas 121 using the adjusted odds values of the adjusted payout-odds data set thus generated. Specifically, the processor 1 sets each of the adjusted odds values as a replacement for the default odds values.

After the processor 1 has updated the payout odds values for the virtual betting areas 121, the processor 1 updates the betting layout image 12 to include the virtual payout-odds indicators 122 that correspond respectively to the adjusted odds values. For the sake of brevity, FIG. 4B only illustrates the virtual payout-odds indicators 122 associated with the virtual betting areas 121 of the number “30”, the first set of numerals (1~12) and the odd number numerals (1, 3 . . . 35) to represent the updated payout odds values. In addition, the processor 1 also generates the mask image 14 to include the virtual payout-odds indicators 122 that correspond to the numbers 0 to 36. Specifically, the virtual payout-odds indicators 122 are placed respectively on the display frames 92 of the mask image 14. That is to say, at this point, when the processor 1 controls the display 5 to display the augmented image 11 including the betting layout image 12, the real-time image 13 and the mask image 14 overlaid on top of the real-time image 13, the player can see the first wager and the second wager on the betting layout image 12 and the roulette wheel 41, as well as the virtual payout-odds indicators 122 displayed on both the betting layout image 12 and the corresponding pockets on the roulette wheel 41 (only one of the virtual payout-odds indicators 122 that corresponds to the number “30” is shown in the augmented image 11 in FIG. 4B).

Further referring to FIG. 4C, in step S5, the processor 1 controls the physical game result generator 2 to randomly generate a game result. In some embodiments, while the roulette wheel 41 is rotating, the virtual payout-odds indicators 122 and the virtual chips 111 on the display frames 92 of the mask image 14 rotate correspondingly with the roulette wheel 41.

In step S6, the processor 1 performs image processing on the real-time image 13, after the roulette ball 42 has stopped moving, to generate the game-result data. The processor 1 updates the betting layout image 12 according to the game-result data. In this first example, the processor 1 generates a virtual ball image 123 representing the roulette ball 42, and places the virtual ball image 123 at one of the virtual betting areas 121 (e.g., the virtual betting area 121 that corresponds to the number “9”) in the betting layout image 12.

In step S7, the processor 1 calculates a payout amount based on the game-result data, the betting data and the payout odds values of the virtual betting areas 121. For example, when the game-result data indicates the number “9”, and the betting data is a wager of 100 credits bet on the virtual betting area 121 of “Area_ID: 9” with payout odds of 35-to-1, the processor 1 calculates a payout amount of 3600 credits.

In step S8, the processor 1 controls the payout unit 6 to distribute the payout amount in the form of cash or payout ticket, or to credit the payout amount to the player's account.

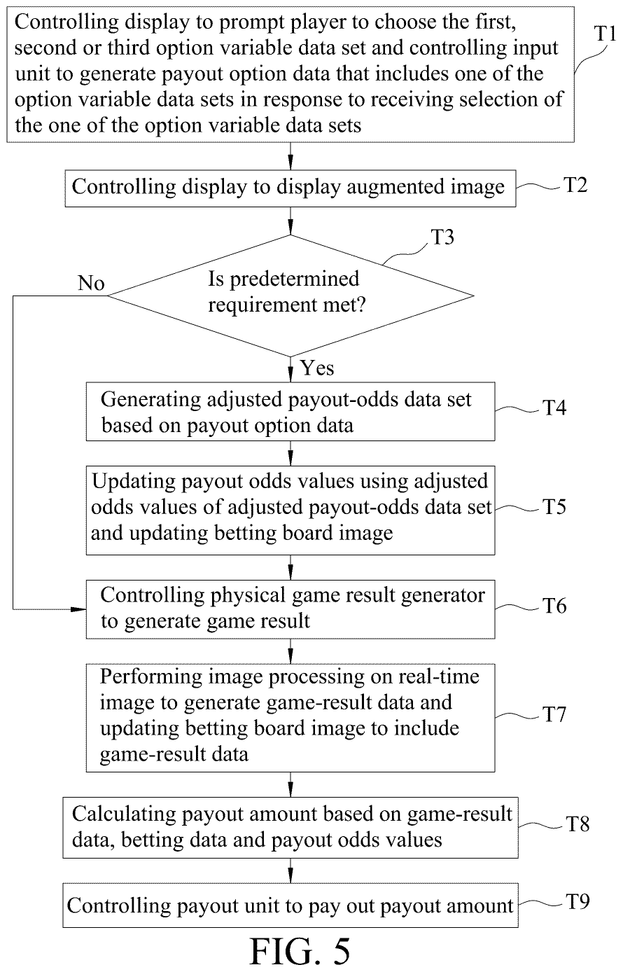

Referring to FIG. 5, a second embodiment of the method for providing an augmented reality gameplay experience is implemented by the game system in FIG. 1. The method includes steps T1 to T9 and is illustrated using a second example of the gambling game, which is the baccarat game.

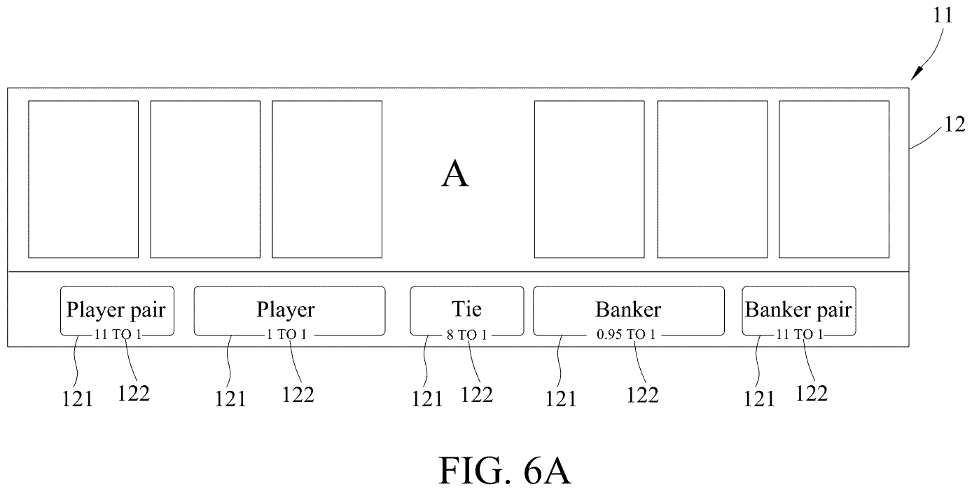

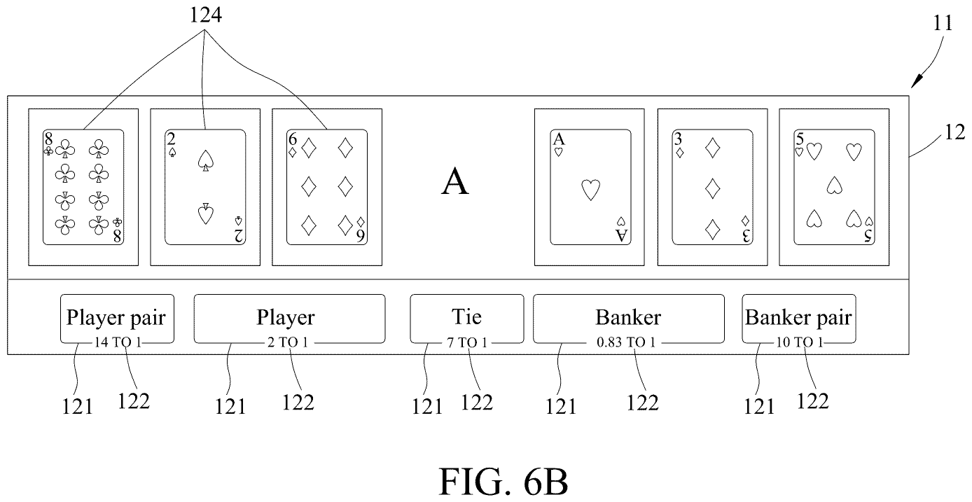

Further referring to FIGS. 6A and 6B, in the second example, the physical game result generator 2 is exemplified by the card dealing device (not shown), and the possible results correspond respectively to different combinations of cards dealt by the card dealing device. In the second example, the default payout-odds data set is presented in Table 3 below.

TABLE 3

| Virtual Betting Areas 121 | Default Odds Values |
|---|---|
| Banker | 0.95 |
| Player | 1 |
| Tie | 8 |
| Banker pair | 11 |
| Player pair | 11 |

In the second example, three variable payout-odds data sets are provided for player selection (hereinafter respectively referred to as a “first option variable data set”, a “second option variable data set” and a “third option variable data set”). An example of the first, second, and third option variable data sets are shown in Table 4 below.

TABLE 4

| Variable | | | |
|---|---|---|---|
| Payout- | | | |
| Odds Data | Virtual Betting | Variable Odds | Probability of |
| Sets | Area 121 | Groups | Appearance |
| First | Banker | (0.83, 2) | (90%, 10%) |
| Option | Player | (0.88, 2) | (90%, 10%) |
| Variable | Tie | (7, 8, 10) | (50%, 30%, 20%) |
| Data Set | Banker pair | (10, 11, 14) | (50%, 35%, 15%) |
| | Player pair | (10, 11, 14) | (50%, 35%, 15%) |
| Second | Banker | (0.85, 2) | (92%, 8%) |
| Option | Player | (0.9, 2) | (92%, 8%) |
| Variable | Tie | (6, 9, 12) | (50%, 35%, 15%) |
| Data Set | Banker pair | (9, 12, 15) | (50%, 35%, 15%) |
| | Player pair | (9, 12, 15) | (50%, 35%, 15%) |
| Third | Banker | (0.8, 3) | (94%, 6%) |
| Option | Player | (0.85, 3) | (94%, 6%) |
| Variable | Tie | (6, 8, 20) | (60%, 30%, 10%) |
| Data Set | Banker pair | (8, 10, 30) | (60%, 30%, 10%) |
| | Player pair | (8, 10, 30) | (60%, 30%, 10%) |

In step T1, the processor 1 first controls the display 5 to prompt a player to choose the first, second or third option variable data set. In this second example, the input unit 4, in response to receiving a selection of one of the option variable data sets (e.g., the first option variable data set) from the player, generates the payout option data that includes the first option variable data set to the processor 1 to update the payout odds values of the virtual betting areas 121. The flow then goes to step T2.

In step T2, the processor 1 controls the display 5 to display the augmented image 11, which includes the betting layout image 12 and the real-time image 13 (not shown in FIGS. 6A and 6B).

In step T3, in response to receiving betting data generated by the player placing a wager on at least one of the virtual betting areas 121 via the input unit 4, the processor 1 determines whether the predetermined requirement (e.g., a total wager placed on the virtual betting areas 121 exceeds a predetermined wager amount set by the operator of the game system) is met. The flow goes to step T4 when the determination is affirmative; otherwise, the flow goes to step T6. In some embodiments, step T3 may be omitted, and thus the flow may go directly to step T4 after step T2 has been executed.

In step T4, the processor 1 generates an adjusted payout-odds data set based on the payout option data received from the input unit 4 earlier in step T1 to replace the default odds values. Specifically, the processor 1 generates the adjusted odds values based on the first option variable data set. An example of the default odds values and the adjusted odds values for the virtual betting areas 121 are presented in Table 5 below. FIG. 6A shows the betting layout image 12 and the payout odds values are respectively set to the default odds values.

TABLE 5

| Virtual Betting Areas 121 | Default Odds Values | Adjusted Odds Values |
|---|---|---|
| Banker | 0.95 | 0.83 |
| Player | 1 | 2 |
| Tie | 8 | 7 |
| Banker pair | 11 | 10 |
| Player pair | 11 | 14 |

In step T5, the processor 1 updates the payout odds values respectively of the virtual betting areas 121 using the adjusted odds values of the adjusted payout-odds data set thus generated.

After the processor 1 has updated the payout odds values of the virtual betting areas 121, the processor 1 updates the betting layout image 12 to include the virtual payout-odds indicators 122. FIG. 6B shows the betting layout image 12 when the payout odds values are respectively set to the adjusted odds values according to Table 5.

In step T6, the processor 1 controls the physical game result generator 2 to generate a game result. In this second example, the game result is represented by a combination of six cards dealt from the card dealing device.

In step T7, the processor 1 performs image processing on the real-time image that includes the game result (i.e., the six cards dealt) to generate the game-result data. In this second example, the game-result data includes images of the six cards, shown as six virtual cards 124 in FIG. 6B.

Steps T8 and T9 of the second embodiment of the method are respectively similar to steps S7 and S8 of the first embodiment of the method, and further descriptions thereof will be omitted for the sake of brevity.

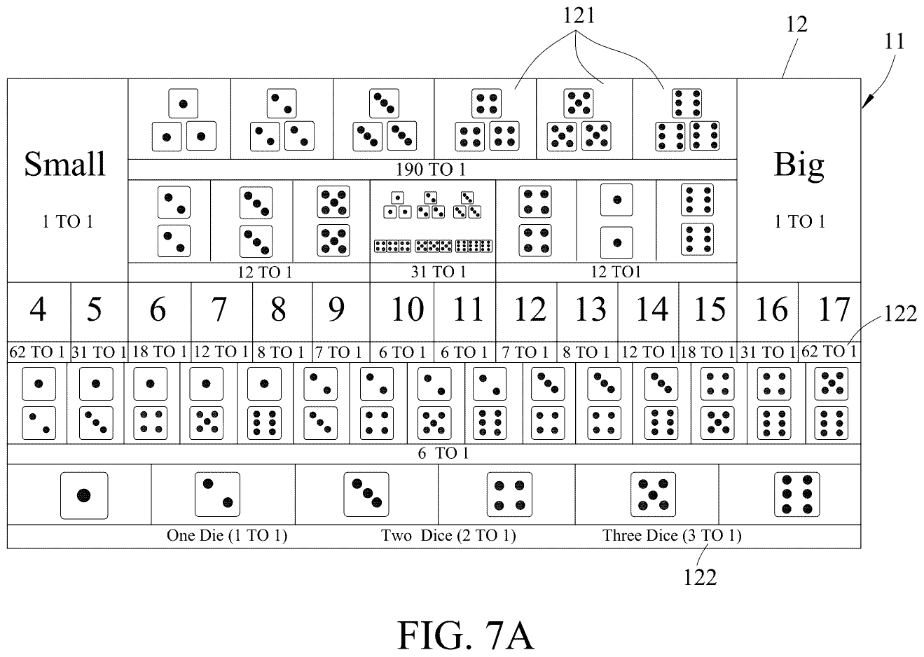

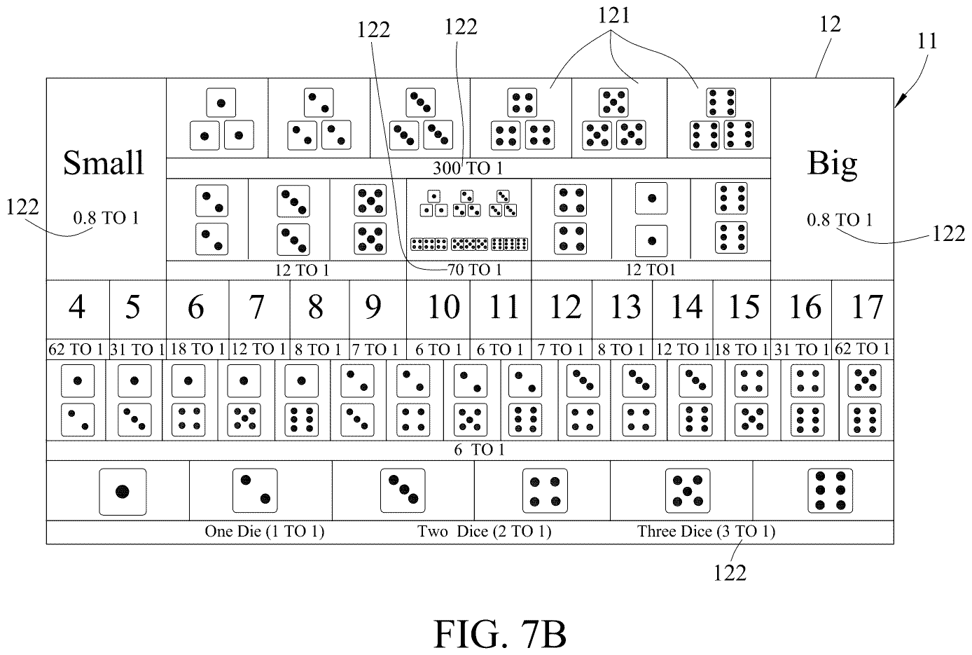

Referring to FIGS. 2, 7A and 7B, a third example of the gambling game played by the game system is presented, illustrating a variation of the second embodiment of the method. In the third example, the gambling game is the Sic Bo game.

In the third example, the physical game result generator 2 is exemplified by the dice rolling device (not shown), and the possible results correspond respectively to different combinations of values of dice rolled by the dice rolling device. The default payout-odds data set is presented in Table 6 below (only some of the virtual betting areas 121 are presented).

TABLE 6

| Virtual Betting Areas 121 | Default Odds Values |
|---|---|
| Big | 1 |
| Small | 1 |
| One Dice | 1 |
| Two Dice | 2 |
| Three Dice | 3 |
| Triple | 190 |

In the third example, the processor 1 is further configured to group the virtual betting areas 121 into a plurality of betting area groups based on the payout odds values of the virtual betting areas 121. For example, the virtual betting areas 121 that correspond to “Big” and “Small”, each having a default odds value of “1”, may be grouped together; however, the disclosure is not limited to this arrangement.

In this variation, steps T1 to T9 that are executed by the processor 1 are similar to those steps T1 to T9 executed in the second embodiment of the method. Therefore, only differences between this variation and the second embodiment will be described hereinafter for the sake of brevity.

In this variation, in step T1, the processor 1 further allows the player to select at least one of the betting area groups via the input unit 4. The input unit 4 then generates the payout option data that includes the at least one of the betting area groups thus selected and transmits the payout option data to the processor 1.

In this third example, an example of one of the at least one variable payout-odds data set and the betting area groups that were selected by the player 5 in step T1 is shown in Table 7 below.

TABLE 7

| Betting Area | Default Odds | Variable Odds | Probability of |
|---|---|---|---|
| Group | Values | Groups | Appearance |
| Big or Small | 1 | (0.8, 3) | (91%, 9%) |
| Any Triple | 31 | (25, 70) | (87%, 13%) |
| Triple | 190 | (150, 300) | (74%, 26%) |

In step T4 of the third example, the default odds values and the adjusted odds values that correspond to the betting area groups thus selected are presented in Table 8 below.

TABLE 8

| Betting Area Group | Default Odds Values | Adjusted Odds Values |
|---|---|---|
| Big or Small | 1 | 0.8 |
| Any Triple | 31 | 70 |
| Triple | 190 | 300 |

In step T5 of the third example, the processor 1 updates the payout odds values for the betting area groups that were selected by the player. That is, the payout odds values of the virtual betting areas 121 that are within the betting area groups are set respectively to corresponding ones of the adjusted odds values; while the virtual betting areas 121 that are not part of the betting area groups that were selected by the player retain the payout odds values that correspond respectively to corresponding ones of the default odds values. FIG. 7A shows the betting layout image 12 when the determination in step T3 of the third example is negative, and the payout odds values are respectively set as the default odds values. FIG. 7B shows the betting layout image 12 when the payout odds values that correspond to the betting area groups are respectively set as the adjusted odds values according to Table 8 above.

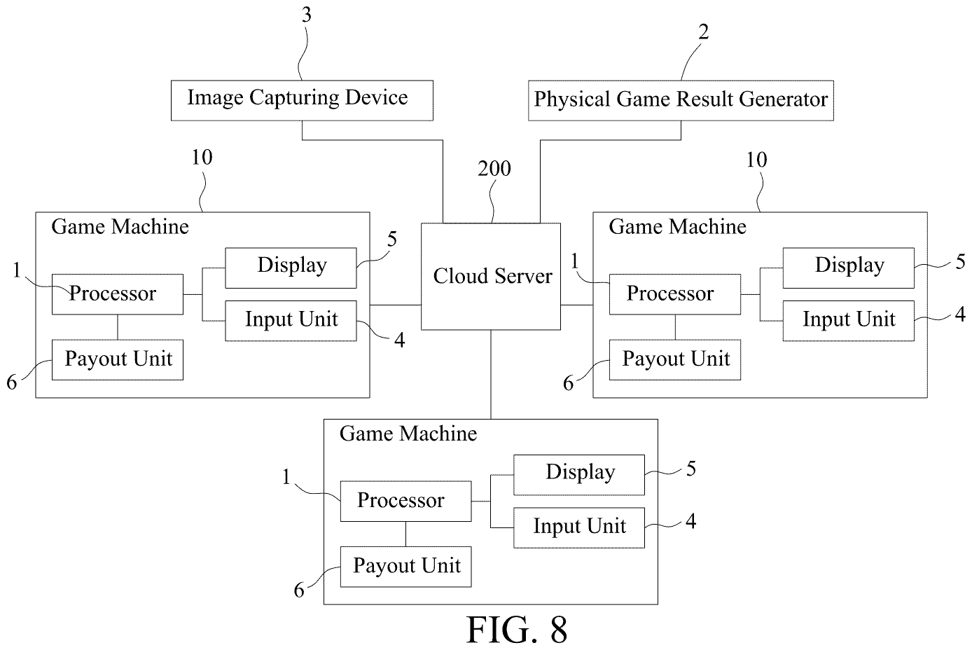

Referring to FIG. 8, in some embodiments of the game system, the game system includes a cloud server 200, an image capturing device 3 and a physical game result generator 2 that are connected to the cloud server 200, and a plurality of game machines 10 that are connected to the cloud server 200. Each of the game machines 10 includes a processor 1, and an input unit 4, a display 5 and a payout unit 6 that are connected to the processor 1. In such embodiments, the processors 1 respectively of the game machines 10 are connected to the image capturing device 3 and the physical game result generator 2 via the cloud server 200. By virtue of such an arrangement, multiple players may simultaneously play each round of the gambling game respectively on the game machines 10, which may be located in different locations.

In summary, the present disclosure provides at least the following advantages:

1. For each of the variable odds groups, by making at least one of the variable odds values smaller than the respective one of the default odds values, and making at least one of the variable odds values greater than the respective one of the default odds values, the variable odds values are generated such that an RTP of each of the corresponding one of the virtual betting areas 121 remains less than 100 percent and an RTP difference relative to the respective one of the default odds values satisfies the predetermined condition. Accordingly, payout odds values that are more attractive to players may be provided while maintaining overall profitability of the gambling game.

2. The player is allowed to select one of the at least one variable payout-odds data set to update the payout odds values, where different variable payout-odds data sets include different variable odds groups and corresponding POAs. As such, the player may participate in the gambling game according to personal preferences while the game system retains control over RTP characteristics.

3. By grouping the virtual betting areas according to the payout odds values and allowing the player to select at least one betting area group, the present disclosure enables only payout odds values respectively of selected virtual betting areas to be updated, while remaining virtual betting areas continue to use default odds values. By virtue of such an arrangement, the game system of this disclosure is able to provide flexibility in updating payout odds values for specific game results without affecting the entire virtual betting area.

4. The predetermined condition related to the RTP difference may be set according to operational or business requirements, such as maintaining the RTP difference to be substantially close to zero or within the predetermined range. By virtue of this arrangement, the operator of the game system is allowed to flexibly adjust a payout behavior of the game system while ensuring regulatory compliance and profitability.

5. The player may input at least one of an upper limit value, a lower limit value, or a number (N) of the variable odds values for the variable odds groups. The processor 1 then determines the variable odds values and the corresponding POAs based on such inputs. By virtue of such an arrangement, the RTP is ensured to satisfy the predetermined condition while supporting personalized gameplay customization.

6. The processor 1 determines whether the predetermined requirement related to the betting data is met before allowing the payout odds values to be updated using the variable payout-odds data sets thus selected. This ensures that the payout odds values are updated only when the predetermined requirement is met, such as when the total wager placed on the virtual betting areas 121 exceeds a predetermined wager amount, thereby improving system control and fairness.

7. By virtue of the processor 1 controlling the display 5 to display the augmented image 11 that includes the betting layout image 12, the real-time image 13 of the physical game result generator 2, and the virtual payout-odds indicators 122 corresponding to the payout odds values that are updated, the game system of this disclosure allows players to intuitively track betting data, game results, and payout odds values in real time. This enhances immersion in live gameplay and reduces cognitive load during participation in the gambling game.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A game system with variable payout odds and augmented reality gameplay functionality for playing at least one round of a gambling game, said game system comprising:
a processor;
a physical game result generator configured to randomly generate a game result in each round of the gambling game;
an image capturing device configured to capture, in real time, an image of a scene including said physical game result generator to generate a real-time image, and to output the real-time image;
an input unit configured to generate betting data and payout option data in response to user operations performed on said input unit, and to output the betting data and the payout option data;
a display configured to display the real-time image and a betting layout image simultaneously; and
a payout unit configured to deliver a payout to a player;
said processor communicatively connected to said physical game result generator, said image capturing device for receiving the real-time image therefrom, said input unit for receiving the betting data and the payout option data therefrom, and said display, and configured to
generate the betting layout image based on the gambling game currently being played, the betting layout image including a plurality of virtual betting areas each assigned with a payout odds value,
update the betting layout image based on the betting data,
update the payout odds values respectively of the plurality of virtual betting areas based on the payout option data,
control said display to display the real-time image and the betting layout image that has been updated,
control said physical game result generator to randomly generate the game result,
calculate a payout amount based on the game result, the betting data and the payout odds values respectively of the plurality of virtual betting areas, and
control said payout unit to deliver the payout based on the payout amount thus calculated.

2. The game system as claimed in claim 1, wherein the game result in each round of the gambling game corresponds to at least one of the plurality of virtual betting areas, and is one of a plurality of possible results that are different from each other and that each have a probability of occurrence, and a return to player (RTP) of the gambling game is obtained based on the probability of occurrence of each of the plurality of possible results and the payout odds values respectively of the plurality of virtual betting areas.

3. The game system as claimed in claim 2, wherein said processor is further configured to generate a mask image that is overlaid on top of the real-time image and that includes a plurality of display frames, the plurality of display frames corresponding respectively to pockets on said physical game result generator in the real-time image, the pockets respectively representing the possible results, and said processor is configured to update the mask image to include the betting data on the plurality of display frames, and control said display to display the real-time image, the mask image and the betting layout image simultaneously.

4. The game system as claimed in claim 1, wherein said processor is further configured to, after said physical game result generator has generated the game result, perform image processing on the real-time image that includes the game result to generate game-result data, update the betting layout image based on the game-result data and calculate the payout amount based on the game-result data, the betting data and the payout odds values respectively of the plurality of virtual betting areas.

5. The game system as claimed in claim 1, wherein said input unit is configured to allow the player to place a wager on at least one of the plurality of virtual betting areas within a predetermined betting time, and in response to the predetermined betting time having lapsed, generate the betting data that includes the wager that was placed on the at least one of the plurality of virtual betting areas.

6. The game system as claimed in claim 1, wherein said processor stores a default payout-odds data set and at least one variable payout-odds data set, the default payout-odds data set includes a plurality of default odds values corresponding respectively to the plurality of virtual betting areas, and each of the at least one variable payout-odds data set includes a plurality of variable odds groups that correspond respectively to the plurality of virtual betting areas;
wherein each of the plurality of variable odds groups includes a plurality of variable odds values each having a probability of appearance (POA);
wherein for each of the plurality of variable odds groups, at least one of the variable odds values is smaller than the respective one of the plurality of default odds values and at least one of the remaining ones of the variable odds values is greater than the respective one of the plurality of default odds values;
wherein in a case where the default payout-odds data set is used as the payout odds values respectively for the plurality of virtual betting areas, a return to player (RTP) of each of the plurality of virtual betting areas is obtained based on the respective one of the plurality of default odds values and a probability of the game result corresponding to the virtual betting area;
wherein in another case where one of the at least one variable payout-odds data set is used to update the payout odds values respectively of the plurality of virtual betting areas, the RTP of each of the plurality of virtual betting areas is obtained based on the respective one of the plurality of variable odds groups and the probability of the game result corresponding to the virtual betting area; and
wherein said processor is further configured to generate the at least one variable payout-odds data set, and for each of the plurality of virtual betting areas, said processor is configured to generate the variable odds values of the respective one of the plurality of variable odds groups such that the RTP of the virtual betting area is less than 100 percent, and a difference between the RTP of the virtual betting area calculated using the respective one of the plurality of default odds values and the RTP of the virtual betting area calculated using the respective one of the plurality of variable odds groups satisfies a predetermined condition.

7. The game system as claimed in claim 6, wherein the predetermined condition is that the difference is substantially zero.

8. The game system as claimed in claim 6, wherein said input unit is further configured to, in response to at least one of an upper limit value of the variable odds values, a lower limit value of the variable odds values and a variable-odds-values number being selectively inputted through said input unit, output the at least one of the upper limit value, the lower limit value and the variable-odds-values number to said processor, the variable-odds-values number being a number of the variable odds values in each of the plurality of variable odds groups; and
wherein said processor is configured to generate the at least one variable payout-odds data set based on the at least one of the upper limit value, the lower limit value and the variable-odds-values number before storing the at least one variable payout-odds data set.

9. The game system as claimed in claim 8, wherein said processor is configured to generate the at least one variable payout-odds data set by using a mathematical method.

10. The game system as claimed in claim 6, wherein said processor is further configured to control said display to display the at least one variable payout-odds data set on said display, and said input unit is configured to, in response to user operations performed on said input unit, generate the payout option data that includes one of the at least one variable payout-odds data set based on the user operations.

11. The game system as claimed in claim 10, wherein said processor is configured to generate an adjusted payout-odds data set that includes a plurality of adjusted odds values corresponding respectively to the plurality of variable odds groups of said one of the at least one variable payout-odds data set, and update the payout odds values respectively of the plurality of virtual betting areas based on the adjusted payout-odds data set;
wherein said processor is further configured to, for each of the plurality of adjusted odds values, determine one of the variable odds values of the corresponding one of the plurality of variable odds groups as the adjusted odds value based on the probabilities of appearance (POAs) respectively of the variable odds values; and
wherein said processor is configured to update the payout odds values by setting each of the payout odds values as the respective one of the adjusted odds values of the adjusted payout-odds data set.

12. The game system as claimed in claim 10, wherein said processor is further configured to group the plurality of virtual betting areas into a plurality of betting area groups, and control said display to display the plurality of betting area groups;
wherein said input unit is further configured to, in response to user operations performed on said input unit, generate the payout option data that further includes at least one of the plurality of betting area groups based on the user operations;
wherein said processor is configured to generate an adjusted payout-odds data set that includes a plurality of adjusted odds values corresponding respectively to the plurality of variable odds groups of said one of the at least one variable payout-odds data set, and update the payout odds values respectively of the plurality of virtual betting areas that correspond to said at least one of the plurality of betting area groups thus selected based on the adjusted payout-odds data set;
wherein said processor is further configured to, for each of the plurality of adjusted odds values, determine one of the variable odds values of the corresponding one of the plurality of variable odds groups as the adjusted odds value based on the probabilities of appearance (POAs) respectively of the variable odds values; and
wherein said processor is further configured to update the payout odds values by setting each of the payout odds values respectively of the plurality of virtual betting areas that correspond to the at least one of the plurality of betting area groups as the respective one of the adjusted odds values of the adjusted payout-odds data set.

13. A method for providing an augmented reality gameplay experience for a game system as claimed in claim 1, said method being implemented by the processor and comprising steps of:
receiving the real-time image from the image capturing device;
generating the betting layout image based on the gambling game currently being played;
updating, in response to receipt of the betting data from the input unit, the betting layout image based on the betting data;
updating, in response to receipt of the payout option data from the input unit, the payout odds values respectively of the plurality of virtual betting areas based on the payout option data;
controlling the display to display the real-time image and the betting layout image that has been updated;
controlling the physical game result generator to randomly generate the game result;
calculating the payout amount based on the game result, the betting data and the payout odds values respectively of the plurality of virtual betting areas; and
controlling the payout unit to deliver the payout based on the payout amount thus calculated.
